(19) United States
(12) Patent Application Publication
(10) Pub. No.: US 2015/0014289 A1
(43) Pub. Date: Jan. 15, 2015

(54) LASER-INDUCED PLASMA DEBURRING

(71) Applicants: Benxin Wu, Naperville, IL (US); Yun Zhou, Fremont, CA (US); Yibo Gao, Shanghai (CN)

(72) Inventors: Benxin Wu, Naperville, IL (US); Yun Zhou, Fremont, CA (US); Yibo Gao, Shanghai (CN)

(21) Appl. No.: 14/329,327

(22) Filed: Jul. 11, 2014

Related U.S. Application Data
(60) Provisional application No. 61/845,674, filed on Jul. 12, 2013.

(51) Int. Cl. B23K 10/00; B23K 26/00

(52) U.S. Cl. CPC B23K 10/003; B23K 26/0054; B23K 26/0075
USPC 219/121.85; 219/121.6

(57) ABSTRACT

Processes and corresponding or associated arrangements for removal of a burr from a workpiece, particularly micromachined workpieces, involving irradiating a plasma plume source material with a laser beam to generate a plasma plume. The plasma plume at least in part impacts the burr disposed on the workpiece to at least in part remove the burr from the workpiece. In select embodiments, the plasma plume source material can be a part of the workpiece or a non-workpiece sacrificial material.

### CROSS REFERENCE TO RELATED APPLICATION

This application claims priority to U.S. Provisional Application, Ser. No. 61/845,674, filed on 12 Jul. 2013. The U.S. Provisional Application is hereby incorporated by reference herein in its entirety and is made a part hereof, including not limited to those portions which specifically appear hereinafter.

### BACKGROUND OF THE INVENTION

1. Field of the Invention

This invention relates generally to manufacture processing and, more particularly, to manufacture processing such as to remove burrs (i.e., deburring), especially from small features or parts.

2. Description of Related Art

Machining and some other manufacturing processes are known to at times generate, produce or otherwise result in the creation, formation or generation of undesired by-products such as commonly known or referred to as “burrs”. The presence of burrs unfortunately can create or result in various and/or consequent problems including problems in or in association with the assembly and/or operation of products or parts. As a result, burrs and the removal (or suppression) thereof have been the subjects of extensive studies.

Micro products and parts are needed and are becoming more and more prevalent in numerous industrial areas including, for example, the medical, optical, electronic and automotive fields. The manufacture of many micro products or parts may require processes such as micromachining that can generate, produce or result in the formation or creation of burrs. In the manufacture, production or processing of parts, the presence or occurrence of burrs can be troublesome. Problems due to or resulting from the presence or occurrence of burrs can be particularly troublesome when the parts being manufactured, produced or processed have high precision requirements such as is often the case in connection with micro features such as produced by micromachining. For example, various useful micro features, such as to which the burrs are attached, may be fragile and can be of very small dimensions or sizes. Therefore, it can be very challenging and difficult to effectively remove burrs from micro features without causing or resulting in damage to the micro features. Moreover, in some circumstances, the deburring process can take more time and/or be more costly than the micromachining processing itself.

Thus, there is a need and a demand for effective deburring technologies, particularly for deburring processes and arrangements suited for application to the deburring of small features or parts such as micromachined objects or parts.

### SUMMARY OF THE INVENTION

This invention provides a new process and arrangements for deburring parts or components or features of parts or components.

As described in greater detail below, in specific embodiments, deburring is achieved via a laser-induced plasma via a processing technique referred to herein as Laser-Induced Plasma Deburring (LPD).

In LPD processing, a plasma plume is generated through laser interaction with a plasma plume source material. With the selection of appropriate and suitable laser and other process parameters, the produced plasma plume can impact the burrs on or attached to the workpiece and remove such burrs if the plasma is sufficiently strong.

As detailed below, in selected embodiments, suitable plasma source materials can be gaseous, liquid or solid. Further, a suitable plasma source material solid (e.g., a solid that is laser-ablated to form, produce or generate a plasma plume) can be a part of the workpiece itself or a part of a non-workpiece sacrificial material, as may be desired in a particular embodiment.

In accordance with a first aspect of the development, there is provided a process for removing a burr from a workpiece.

In one embodiment, such a process involves irradiating a plasma plume source material with a laser beam to generate a plasma plume. The plasma plume at least in part impacts the burr disposed on the workpiece to at least in part remove the burr from the workpiece.

In another embodiment, such a process involves irradiating a plasma plume source material solid object with a laser beam from a laser to generate a plasma plume. The plasma plume at least in part impacts a burr disposed on a surface of the workpiece to at least in part remove the burr from the workpiece surface.

In another aspect of the invention there is provided an arrangement for removing a burr from a workpiece.

In accordance with one preferred embodiment, such an arrangement includes a mount for mounting a workpiece having a burr disposed on a surface of the workpiece. The arrangement further includes a laser for irradiating a plasma plume source material with a laser beam to generate a plasma plume. The plasma plume at least in part impacts the burr disposed on the surface of the workpiece to at least in part remove the burr from the workpiece surface.

As used herein, references to the removal of a burr located on or attached to a workpiece are to be understood as involving impact via a plasma sufficiently strong to effect such removal.

### BRIEF DESCRIPTION OF THE DRAWINGS

Objects and features of this invention will be better understood from the following description taken in conjunction with the drawings, wherein:

FIG. 1 is a schematic diagram of an arrangement to remove burrs from a sidewall of a blind hole or channel in accordance with one embodiment of the invention;

FIG. 2 is a schematic diagram of an arrangement to remove burrs from a sidewall of a through hole or channel in accordance with one embodiment of the invention; and

FIG. 3 is a schematic diagram of an arrangement to remove burrs from an outer surface of a workpiece in accordance with one embodiment of the invention.

### DESCRIPTION OF THE INVENTION

The invention generally relates to deburring of parts or components or features of parts or components. In certain more specific aspects of the invention, there is provided deburring processing that may have particular attractiveness for the removal of burrs from micro features or micromachined parts or components.

As described in greater detail below, in one preferred aspect of the invention, LPD processing advantageously utilizes the plasma produced by laser-material interaction to remove burrs.

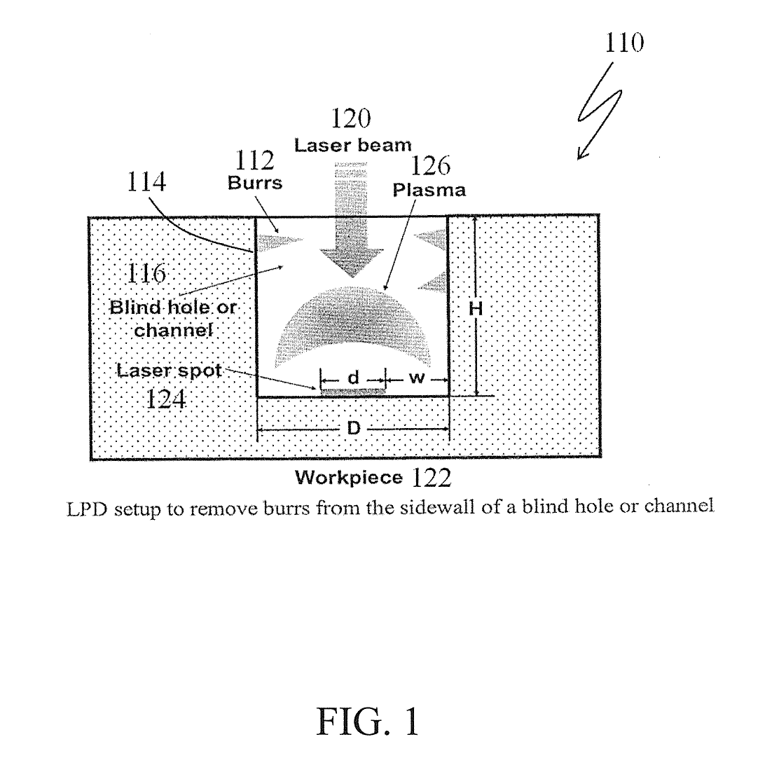

As will be appreciated by those skilled in the art and guided by the teachings herein provided, LPD processing in accordance with the invention can be practiced or realized employing various specific arrangements such as dependent on one or more of the following variables or parameters, including (but not limited to): workpiece material type, size and shape, and the size, shape and location of the burrs on the workpiece. FIGS. 1 to 3 illustrate some specific examples of arrangements for burr removal in accordance with particular embodiments of the invention. It is to be understood, however, that the broader practice of the invention is not necessarily limited to or by such specifically illustrated arrangements. In particular, any specific setup or arrangement that utilizes a plasma such as induced by laser irradiation of a plasma source material (such as produced or formed, for example, via laser ablation of a solid object or via laser-induced breakdown of a gas or liquid medium) to remove burrs is to be regarded as included in and a part of the broader practice of the subject invention development. Further, in arrangements such as shown in FIGS. 1 to 3, parameters such as variation of laser output power with time (continuous-wave or pulsed), laser pulse duration and its temporal shape (if a pulsed laser is used), laser beam intensity and its spatial distribution, laser wavelength, laser spot size, laser pulse repetition rate, pulse number, laser ablation location, laser spot scanning speed, etc., are process parameters that those skilled in the art and guided by the teachings herein provided can appropriately adjust to obtain or realize the best results for or under different specific situations.

FIG. 1 shows an arrangement, generally designated by the reference numeral 110, for the removal of burrs 112 from a sidewall 114 of a blind hole or blind channel 116, in accordance with one embodiment of the invention. A laser beam 120 irradiates onto the bottom of the hole or channel 116, such as onto the workpiece 122 at a laser spot 124. The laser ablation process generates a plasma plume 126 that can desirably impact and remove the burrs 112 on the sidewall 114 of the hole or channel 116.

FIG. 1 also shows and includes:

H=depth or height of hole/channel 116;

D=diameter/width of hole/channel 116;

d=diameter/width of laser spot 124; and

2=horizontal spacing from the boundary of laser spot 124 to the sidewall of the hole or channel 116.

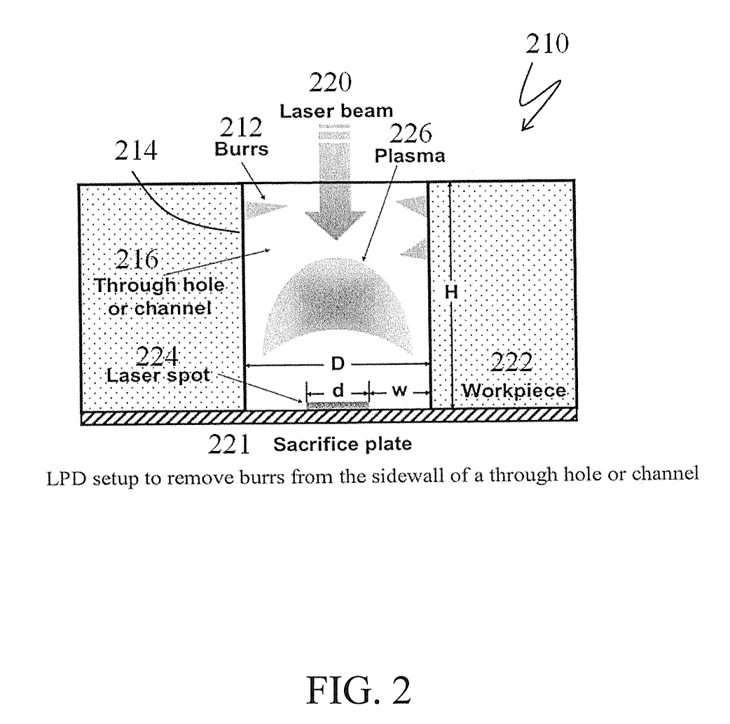

FIG. 2 shows an arrangement, generally designated by the reference numeral 210, for the removal of burrs 212 from a sidewall 214 of a through hole or channel 216. In the processing arrangement 210, a laser beam 220 irradiates onto a sacrificial object or plate 221 (i.e., an object or plate different and independent from the workpiece 222) such as at a laser spot 224. The laser ablation process generates a plasma plume 226 that can impact and remove the burrs 212 on the sidewall 214 of the hole or channel 216. Through the use of a non-workpiece sacrificial material or plate, laser ablation of the workpiece itself can be avoided and hence such practice avoids material removal from the workpiece due to laser ablation at the ablation location.

FIG. 2 also shows and includes:

H=depth or height of hole/channel 216;

D=diameter/width of hole/channel 216;

d=diameter/width of laser spot 224; and

w=horizontal spacing from the boundary of laser spot 224 to the sidewall of the hole or channel 216.

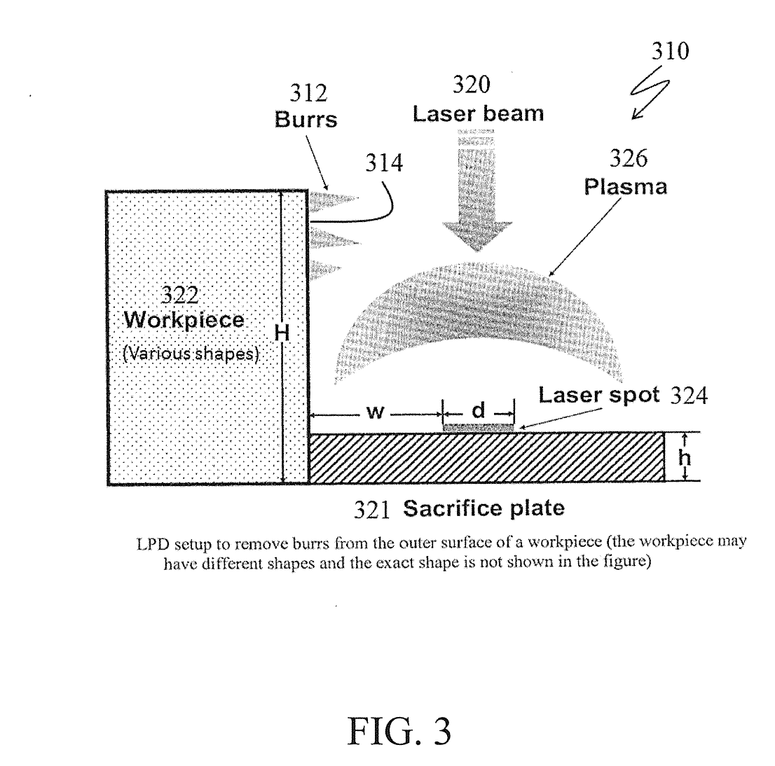

FIG. 3 shows an arrangement, generally designated by the reference numeral 310, for the removal of burrs 312 from an outer surface 314 of a workpiece 322. As will be appreciated, workpieces of various size and shape can be used in such an arrangement and thus the broader practice of this aspect of the invention is to be understood such as not limited to specific workpiece sizes or shapes let alone to a particular or specific size and/or shape. Thus, in FIG. 3, the workpiece 322 is simply schematically shown or represented. In the processing arrangement 310, a laser beam 320 irradiates onto a sacrificial object or plate 321 (e.g., a non-workpiece sacrificial material, i.e., an object or plate different and independent from the workpiece 322) such as at a laser spot 324. The laser ablation process desirably generates a plasma plume 326 that can impact and remove the burrs 312.

FIG. 3 also shows and includes:

H=size of workpiece 322 in the indicated direction;

h=thickness of sacrificial plate 321;

d=diameter/width of laser spot 324; and

w=horizontal spacing from the boundary of laser spot 324 to workpiece 322.

LPD processing, in accordance with one preferred aspect of the invention, does not utilize direct laser radiation onto the burrs or direct contact of mechanical tools with burrs, and hence such processing can desirably minimize, reduce and/or avoid the possibility of seriously mechanically or thermally damaging the useful workpiece features to which the burrs are attached.

As a specific example, LPD has been studied on titanium workpieces using ˜200-ns (full pulse duration) and ˜1064-nm laser pulses with a pulse energy of less than 1 mJ per pulse (using a laser from SPI) to remove (i) burrs from the sidewalls of micro channels produced by electrical discharge machining (micro channel widths: roughly around ˜200 μm or ˜110 μm), and (ii) burrs from a workpiece cutting cross section induced by mechanical saw (workpiece thickness: around ˜0.9 mm).

For (i), the plasma plume was generated by laser ablation of the channel bottom. For each channel, multiple different locations of the channel bottom were laser-ablated, and typically around 10 laser pulses were applied at each location. It has been found that under the studied conditions, most of the burrs have been removed from micro channel sidewalls by LPD and further no obvious size or shape variations of the sidewalls themselves were shown in the optical microscopic images that were taken in the study.

For (ii), the plasma plume was generated by laser ablation of a sacrifice plate. Multiple locations of the sacrifice plate along a laser scan line were ablated. In the study, scanning electron microscopic (SEM) images taken before and after LPD showed effective burr removal in the image field.

As will be appreciated by those skilled in the art and guided by the teachings herein provided, through LPD processing in accordance with the invention, the following potential advantages (particularly for deburring micro features) may be realized:

1. Non-contact and no mechanical machining tool wear: LPD processing utilizes laser beam(s) without involving the contact of mechanical machining tools with the workpiece, and hence does not experience the problem of mechanical machining tool wear.

2. High spatial resolution: laser beam(s) can be focused to a small location or spot down to less than 10 microns in size.

3. Expected low possibility of seriously damaging useful workpiece features if suitable process parameters are chosen.

In accordance with one aspect of the invention, there is provided a process for removing a burr from a workpiece, i.e., to deburr the workpiece. One such deburring process involves irradiating a material object with a laser beam to produce, create or form a plasma plume, and the plasma plume can then impact and remove the burr from the workpiece.

In one particular embodiment, the material object that is irradiated with the laser beam is the workpiece itself.

In another particular embodiment, the material object that is irradiated with the laser beam is a sacrificial plate or object.

In accordance with particular embodiments of the invention, burr(s) that may be removed via practice of the invention can, for example, be on:

1. a sidewall of a blind hole or channel;

2. a sidewall of a through hole of channel; or

3. an outer surface of a workpiece of various size and/or shape.

While further research work will be needed to completely understand the fundamental burr-removal mechanisms in LPD, which may depend on laser parameters and/or other process conditions, it is currently believed or theorized that burr removal mechanisms involved in the practice of the invention and realized via a plasma plume at least in part impacting a burr disposed on the workpiece to at least in part remove the burr from the workpiece may involve or result from: (i) mechanical breaking of burrs due to the plasma and/or the associated or corresponding shock wave and/or the compressed ambient gas at or near the plasma expansion front, and/or (ii) burr heating, softening, and/or phase transformations due to thermal energy from plasma, and/or (iii) other possible mechanisms.

As long as a process utilizes plasma induced by laser ablation of solids (or plasma induced by laser breakdown of a gas or liquid medium) to remove burrs, it should be regarded as a part of this invention. Further, in the broader practice of the invention, such inclusion is considered independent of:

(i) the workpiece size, shape or material type,

(ii) burr size, shape, or location,

(iii) laser parameters and laser optics parameters, and

(iv) other process conditions or parameters.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A process for removing a burr from a workpiece, the process comprising:
irradiating a plasma plume source material with a laser beam to generate a plasma plume, the plasma plume at least in part impacting the burr disposed on the workpiece to at least in part remove the burr from the workpiece.

2. The process of claim 1 wherein the plasma plume source material is a solid object.

3. The process of claim 2 wherein the solid object is at least in part the workpiece.

4. The process of claim 2 wherein the solid object comprises a non-workpiece sacrificial material.

5. The process of claim 1 wherein the burr is at least in part disposed on an outer surface of the workpiece.

6. The process of claim 1 wherein the burr is disposed at least in part on a side wall of a blind hole or channel in the workpiece.

7. The process of claim 1 wherein the burr is disposed at least in part on a side wall of a through hole or channel in the workpiece.

8. The process of claim 1 wherein the plasma plume source material is a gaseous medium.

9. The process of claim 1 wherein the plasma plume source material is a liquid medium.

10. The process of claim 1 wherein the workpiece is a micromachined object.

11. The process of claim 1 wherein the laser beam is produced by a continuous wave laser.

12. The process of claim 1 wherein the laser beam is produced by a pulsed laser.

13. A process for removing a burr from a micromachined workpiece, the process comprising:
irradiating a plasma plume source material solid object with a laser beam from a laser to generate a plasma plume, the plasma plume at least in part impacting the burr disposed on a micromachined surface of the workpiece to at least in part remove the burr from the workpiece surface.

14. The process of claim 13 wherein the plasma plume source material solid object is at least in part the workpiece.

15. The process of claim 13 wherein the plasma plume source material solid object comprises a non-workpiece sacrificial material.

16. The process of claim 13 wherein the burr is at least in part disposed on an outer surface of the workpiece.

17. The process of claim 13 wherein the burr is disposed at least in part on a side wall of a blind hole or channel in the workpiece.

18. The process of claim 13 wherein the burr is disposed at least in part on a side wall of a through hole or channel in the workpiece.

19. The process of claim 13 wherein the laser beam is produced by a continuous wave laser.

20. The process of claim 13 wherein the laser beam is produced by a pulsed laser.

21. An arrangement for removing a burr from a workpiece, the arrangement comprising:
a mount for mounting a workpiece having a burr disposed on a surface of the workpiece and
a laser for irradiating a plasma plume source material with a laser beam to generate a plasma plume, the plasma plume at least in part impacting the burr disposed on the surface of the workpiece to at least in part remove the burr from the workpiece surface.
